(19) United States
(12) Patent Application Publication
(10) Pub. No.: US 2017/0034227 A1
(43) Pub. Date: Feb. 2, 2017

(54) SYSTEM AND METHODS FOR AN ONLINE CONFERENCE SESSION

(71) Applicant: Cisco Technology, Inc., San Jose, CA (US)

(72) Inventors: Mingfeng Yang, Hefei (CN); Yasi Xi, Hefei (CN); Changming He, Hefei (CN); Renhua Kan, Hefei (CN)

(21) Appl. No.: 14/880,309

(22) Filed: Oct. 12, 2015

(30) Foreign Application Priority Data
Jul. 31, 2015 (CN) PCT/CN2014/093901

(51) Int. Cl. H04L 29/06; H04L 29/08; G06Q 10/10

(52) U.S. Cl. CPC H04L 65/403; G06Q 10/1095; H04L 65/604; H04L 67/1021

(57) ABSTRACT

In one embodiment, a method includes: facilitating an online conference session between a plurality of client devices connected to a meeting server; storing information related to one or more backup client devices, the one or more backup client devices corresponding to client devices that accepted to share their computing resources, and the information comprising, for each of the one or more backup client devices a network address and an amount of available computing resources; receiving, from a client device connected to the meeting server, a request to identify a backup client device operative to process data in place of the client device; and, in response to the request, using the stored information to identify at least one backup client device from the one or more backup client devices, the at least one backup client device having sufficient computing resources available to process the data.

### TECHNICAL FIELD

The present disclosure relates generally to management of client devices in an online conference session.

### BACKGROUND

Online/web-based meetings allow participants to share documents, audio, video, and other data through connections to a meeting server. A participant wanting to join the online meeting typically uses a client device to connect to the meeting server. However, in a situation where the participant wants to share data with the other participants, he is constrained by the resources and capabilities of his client device. If the client device is not powerful enough to properly decode and publish the data, this may lead to the data not being properly shared and/or not shared at all.

### BRIEF DESCRIPTION OF THE DRAWINGS

The present invention will be understood and appreciated more fully from the following detailed description, taken in conjunction with the drawings in which:

FIG. 1 is a simplified block diagram illustration of an online conference system 100, constructed and operative in accordance with an embodiment of the present invention;

FIG. 2 is a simplified block diagram illustration of a meeting server 110, constructed and operative in accordance with an embodiment of the present invention;

FIG. 3 is a simplified block diagram illustration of an online conference system 100, constructed and operative in accordance with another embodiment of the present invention;

FIG. 4 is a simplified block diagram illustration of an online conference system 100, constructed and operative in accordance with another embodiment of the present invention;

FIG. 5 is a flow chart diagram of a method for facilitating an online conference session between a plurality of client devices connected to a meeting server in accordance with an embodiment of the present invention; and

FIG. 6 is a flow chart diagram of a method for a backup client device to process data for a requesting client in accordance with an embodiment of the present invention.

### DESCRIPTION OF EXAMPLE EMBODIMENTS

### Overview

In one embodiment, a method implemented on a meeting server connected to a plurality of client devices, the method includes: facilitating an online conference session between a plurality of client devices, the plurality of client devices being connected to the meeting server; storing information related to one or more backup client devices, the one or more backup client devices corresponding to one or more of the plurality of client devices that accepted to share their computing resources, and the information comprising, for each of the one or more backup client devices a network address and an amount of available computing resources; receiving, from a client device connected to the meeting server, a request to identify a backup client device operative to process data in place of the client device; and, in response to the request, using the stored information to identify at least one backup client device from the one or more backup client devices, the at least one backup client device having sufficient computing resources available to process the data.

### Detailed Description of Exemplary Embodiments

In the following description, numerous specific details are set forth in order to provide a thorough understanding of the various principles of the present invention. However, those skilled in the art will appreciate that not all these details are necessarily always required for practicing the present invention. In this instance, well-known circuits, control logic, and the details of computer program instructions for conventional algorithms and processes have not been shown in detail in order not to obscure the general concepts unnecessarily.

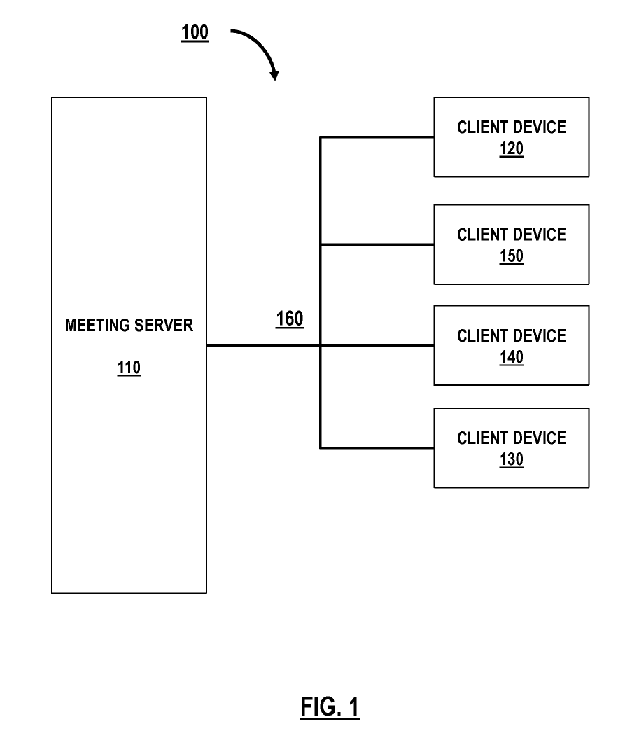

Reference is now made to FIG. 1, which is a simplified block diagram illustration of an online conference system 100, constructed and operative in accordance with an embodiment of the present invention.

FIG. 1 shows an online conference system 100 with a meeting server 110 enabling client devices 120, 130, 140 and 150 to share data (e.g. documents, audio, video, other data, etc.) in an online conference session 160. The different client devices 120 to 150 join the online conference session 160 by sending messages to the meeting server 110. Although only four client devices 120, 130, 140 and 150 are shown in FIG. 1, those skilled in the art will appreciate that any number of client devices may be included in the online conference system 100. Client devices 120 to 150 may take a variety of forms such as, for example, but not limited to, a desktop computer, laptop computer, mobile/cellular phone, tablet computer, handheld device; etc. as long as they have connectivity capabilities to communicate and connect to the meeting server 110, etc.

Typical implementations of client devices 120 to 150 comprise at least one processor, one of which may be a special purpose processor operative to perform the methods for connecting to the online conference session, according to the methods described herein. In addition, the computing device comprises non-transitory processor-readable storage media (e.g. memory). The memory may store instructions, which at least one of the processors may execute, in order to perform the methods described herein. The computing device further comprises standard hardware and software components as are known in the art not specifically described herein, for the sake of brevity.

Online conference session 160 may be conducted over any type of one or more networks (e.g. any combination of Internet, intranet, local area network (LAN), wide area network (WAN), wired network, wireless network, etc.) that connects the meeting server 110 to the client devices 120 to 150. Meeting server 110 may be used, for example, to mediate transactions between the different client devices 120 to 150. Meeting server 110 may also perform caching or other time/bandwidth saving techniques.

In a web-based conference system, each of the client devices 120 to 150 may communicate with the meeting server 110 through a browser application having one or more plug-ins that enable web-based meeting(s), and allow the transmission of data to the meeting server 110 as well as the reception of data from the meeting server 110 during an online conference/meeting session.

In one example embodiment of the present invention, when a client device connects to the online conference session 160 and registers with meeting server 110, the meeting server 110 is operative to determine whether or not the client device is to be added to a backup client device pool. For each backup client device added to the pool, the meeting server 110 is further operative to determine the available backup capabilities and resources (e.g. memory, computing processing unit (CPU), graphics processing unit (GPU), etc.). For the sake of simplicity of description, the term ‘resources’ will be used in the present specification instead of ‘resources and/or capabilities’ although those skilled in the art will appreciate that both terms (i.e. resources and capabilities) are intended to be encompassed by the use of the term ‘resources’. Then, in a situation where a client device (e.g. client device 120) shares data with the other client devices 130 to 150 via the meeting server 110 but is not powerful enough, fast enough or simply cannot process the data, the meeting server 110 is configured to identify one or more relevant backup client devices, from the backup client device pool, operative to process some or all the data in place of client device 120.

Once one or more relevant backup client devices are identified (e.g. one or more of the client devices 130 to 150 connected to the online conference session 160 other than client device 120), the meeting server 110 is operative to instruct client device 120 which backup client device(s) to transmit some or all the data. The client device 120 therefore transmits the data to the identified backup client device(s) for processing. Then, the processed data are transmitted to the meeting server 110, either directly or via the client device 120, so that they can be shared with the other client devices during the online conference session 160.

Additionally and/or alternatively, once one or more relevant backup client devices are identified (e.g. one or more of the client devices 130 to 150 connected to the online conference session 160 other than client device 120), the meeting server 110 is operative to transmit some or all the data received from the client device 120 directly to the identified one or more relevant backup client devices. Then, the processed data are transmitted back to the meeting server 110 which is further operative to share them with the other client devices during the online conference session 160.

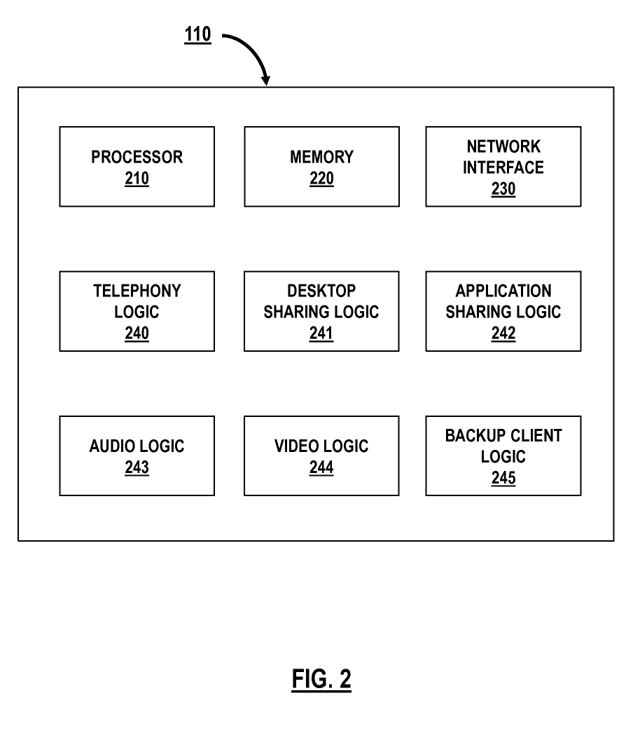

Reference is now made to FIG. 2, which is a simplified block diagram illustration of a meeting server 110, constructed and operative in accordance with an embodiment of the present invention.

Meeting server 110 comprises at least one processor 210 to process instructions relevant to an online conference/meeting session supported by the online conference system 100 and at least one memory 220 to store a variety of data and software instructions (e.g. display data for shared documents, applications, backup client devices data, as well as software instructions for a browser application to enable connectivity and display of data during an online conference/meeting session, etc.).

Meeting server 110 also comprises at least one network interface unit 230 (e.g. one or more interface card or switches) to communicate with other devices over one or more networks. Furthermore, although FIG. 1 depicts the meeting server 110 in direct communication with the client devices 120 to 150, it will be apparent to those skilled in the art that the meeting server 110 may communicate with the client devices 120 to 160 via intermediate devices such as conventional gateways, routers, switches, proxy client devices, etc.

Meeting server 110 may additionally comprise telephone service logic 240, desktop sharing logic 241, application service sharing logic 242, audio service logic 243, video service logic 244 and backup client device logic 245. These functional blocks 240 to 245 may be embodied by dedicated or combined application specific integrated circuits (ASICs) containing digital logic. Alternatively, one or more of these functional blocks 240 to 245 may be embodied in software stored in memory 220 and executed by processor 210.

Memory 220 may comprise read only memory (ROM), random access memory (RAM), magnetic disk storage media devices, optical storage media devices, flash memory devices, electrical, optical, or other physical/tangible (e.g. non-transitory) memory storage devices. The processor 210 may be, for example, a microprocessor or microcontroller that executes instructions for implementing the processes described herein. Thus, in general, the memory 220 may comprise on or more tangible (non-transitory) computer readable storage media (e.g. a memory device) encoded with software comprising computer executable instructions and when the software is executed by the processor 210, it is operative to perform the operations described hereinafter.

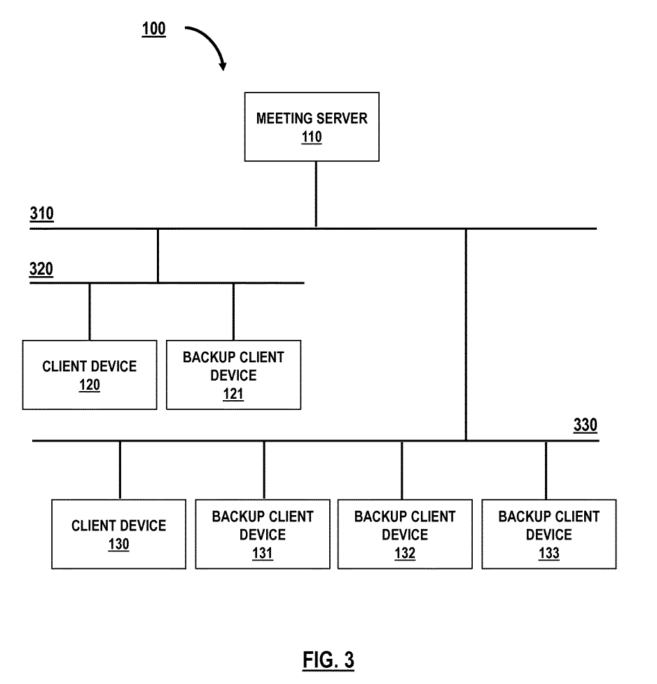

Reference is now made to FIG. 3, which is a simplified block diagram illustration of an online conference system 100, constructed and operative in accordance with another embodiment of the present invention. FIG. 3 shows an online conference system 100 similar to the one presented in FIG. 1. The online conference system 100 comprises a meeting server 110 connected to network 310, two client devices 120 and 121 connected to a first LAN 320, and four client devices 130, 131, 132 and 133 connected to a second LAN 330. Each client device 120, 121 and 130 to 133 registers with the meeting server 110 at the time when they join the online conference session. A client device registering with the meeting server 110 typically sends a set of parameters (e.g. client identifier, client internet protocol (IP) address, gateway address, etc.) to the meeting server 110 which stores them for later use. These parameters enable the meeting server 110 to authenticate the client devices and, in turn, facilitate the online conference/meeting session.

Generally, most of the participants attending an online conference session stay in front of their client devices merely listening to/watching the data shared during the ongoing conversation, presentation, etc. In such a case, the client devices of such participants perform basic audio/video (AV) processing tasks such as, for example, AV receiving, decoding and playing while most of the client devices' computing resources (e.g. CPU, GPU, memory, etc.) remain in idle state. In an example embodiment of the present invention, participants in the online conference session may accept to add their client devices (e.g. client devices 120 to 133) to a backup client device pool. By doing so, they accept that at least some of the available remaining computing resources of their client devices be used by the online conference system 100 to perform meeting related services/tasks for other client devices.

FIG. 3 shows four backup client devices 121, 131, 132 and 133 corresponding to client devices for which participants have accepted to be added to the backup client device pool. Adding a client device to the backup client device pool may be done at any suitable time. For example, a participant may have configured (e.g. set a preference setting) his client device so that it is automatically added to the backup client device pool during the registration process. In another example, the participant may be asked by the meeting application and accepts to add his client device to the pool at the time when his client device registers with the meeting server 110. In a further example, the participant may decide to add his client device to the pool during the online conference session upon receiving a further request by the meeting application and/or on a voluntary basis.

In a further example embodiment of the present invention, the participant who accepts to add his client device to the backup client device pool may define how his client device is to be used in backup client device mode. For example, the participant may define thresholds not to be exceeded for the available remaining computing resources of his client device when his client device is used as a backup client device for another client device of the online conference session. For example, the participant may decide to allocate a particular percentage of his client device's remaining available computing resources (e.g. 50%, 33%, 25%, etc.) to perform meeting related tasks for another client device. Additionally and/or alternatively, the participant may define different thresholds for the different available remaining computing resources of his client device. For example, the participant may decide to allocate up to 50% of the remaining available memory, and up to 25% of the processing capacities of the GPU and/or CPU, etc. to perform meeting related tasks for another client device.

In any case, upon receiving messages from the client devices accepting to be added to the backup client device pool, the meeting server 110 is operative to determine an amount of available remaining computing resources for the backup client device to process data for another client device. In one example, a monitor server (not shown in FIG. 3), provided as a separate device and/or integral with meeting server 110, may be operative to monitor the available remaining computing resources of the different backup client devices 121, 131, 132 and 133. Additionally and/or alternatively, the backup client devices 121, 131, 132 and 133 may perform an auto-diagnostic to evaluate their current performances and send the results to the meeting server 110. The monitored and/or received data for each backup client device are then stored in a memory of the meeting server 110 along with the corresponding set of parameters received during the registration process. Therefore, the meeting server 110 knows which client devices in the online conference session may be used as backup client devices and their amounts of available remaining computing resources.

During the online conference session, the participant using client device 120 may be willing to share, for example, AV data with other participants. However, for some reason, the participant's client device 120 may not be able to decode the AV data. Client device 120 may therefore request meeting server 110 to identify one or more backup client device that will be able to decode the AV data. Meeting server 110 processes the request by identifying one or more relevant backup client devices (e.g. backup client device 121) and then, either transmits the AV data to be processed directly to the identified one or more backup client devices or transmits information identifying the one or more backup client devices to client device 120. Similar operations may take place for client devices on LAN 330. For example, the participant using client device 130 may not be able to process some data. Once instructed, meeting server 110 may identify one or more of backup client devices 131, 132 and/or 133 to process the data for client device 130.

In order to identify one or more relevant backup client devices for a requesting client, meeting server 110 first analyzes the request received from the requesting client. Analyzing the request includes determining, for example, but not limited to, the type of task to be performed as well as the amount and type of data to process for the requesting client. After this analysis, the meeting server 110 parses the information about the different backup client devices stored in memory. At this stage, selection rules may be applied by the meeting server 110 to identify one or more relevant backup client devices. The selection rules may be based on various criteria such as for example, but not limited to, one or more of: the available computing resources and capacities of a backup client device; the available GPU capacity of a backup client device; the available CPU capacity of a backup device; the available quantity of memory of a backup device; the type of data supported by a backup client device; the type of connections supported by a backup client device; the geographical proximity of a backup client device; the network bandwidth usable by a backup client device; etc. Non-limiting examples of selection rules may include: selecting a single backup client device connected on the same LAN as the requesting client and having sufficient available computing resources and/or capacities to process the data for the requesting client; selecting one or more backup client devices connected on the same LAN as the requesting client and having sufficient aggregate available computing resources and capacities to process the task for the requesting client; selecting a first backup client device having sufficient computing resources to process a first portion of the data and a second backup client device having sufficient computing resources to process a second portion of the data to be processed; etc.

Once the one or more relevant backup client devices are identified, the meeting server 110 may send the data to be processed directly to the selected one or more backup client devices or may send information identifying the one or more backup client devices to the requesting client. In the latter case, the information sent to the requesting client comprises at least client identifiers and client network addresses of the identified one or more relevant backup client devices thereby allowing the requesting client to transmit the data to be processed to the identified one or more relevant backup client devices. Once processed by the backup client devices, the processed data may be transmitted back to the meeting server 110 or to the requesting client for subsequent sharing with the other client devices present in the online conference session.

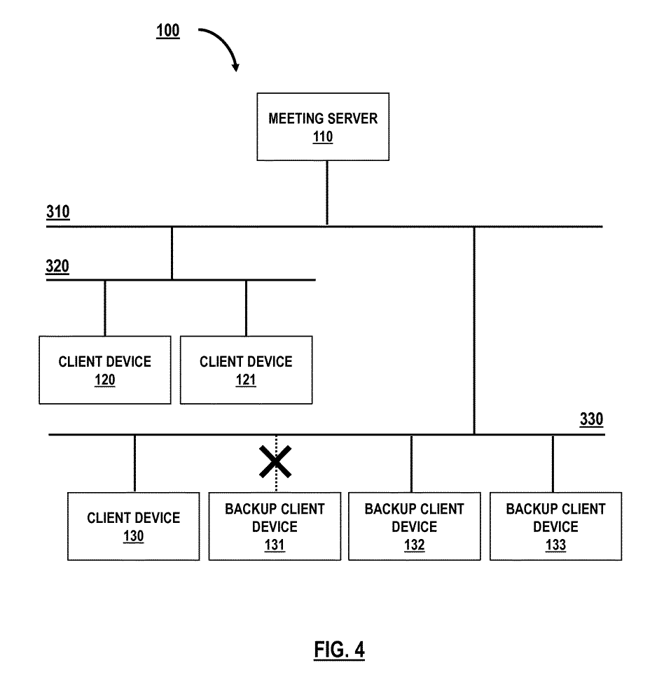

Reference is now made to FIG. 4, which is a simplified block diagram illustration of an online conference system 100, constructed and operative in accordance with another embodiment of the present invention. FIG. 4 depicts the same components as the ones shown in FIG. 3.

However, in FIG. 4, backup client device 131 is no longer connected to the online conference session and client device 121 is no longer a backup client device.

For example, the participant using backup client device 131 may decide to leave the online conference session. Therefore, since backup client device 131 is no longer connected to the online conference session, it can no longer be used as a backup client device. As a result of backup client device 131 leaving the online conference session, meeting server 100 updates the backup client device pool by removing the data and parameters related to backup client device 131.

Additionally and/or alternatively, the participant using client device 121 may decide that his client device 121 should no longer be used as a backup client device. For example, the participant may want to perform some other tasks with his client device 121 in parallel to attending the online conference session. Therefore, the participant using client device 121 may instruct the meeting server 110 to update the backup client device pool so that his client device 132 is removed from the backup client device pool.

Additionally and/or alternatively, the participant may set new thresholds for the available remaining computing resources of his client device. For example, the participant may decide to allocate 0% of the remaining available computing resources of his client device 121 to perform meeting related tasks for another client. In this situation, although his client device 121 is still in the backup client device pool, the backup client device pool is updated with the new threshold(s) and, in turn, his client device 121 cannot be used as a backup client device.

In the different examples described hereinabove, the backup client device pool is updated and this may lead to situations where a particular client device can no longer be used as a backup client device. If such a situation occurs at the time when the backup client device to be removed from the backup client device pool (e.g. backup client device 131 and/or client device 121) is currently being used as a backup client device for another client device, a new backup client device is to be identified. The meeting server 110 may detect the update and perform again the processes described hereinabove to identify and select one or more relevant backup client devices.

In a further example, for each backup client device identified and selected as a backup client device for a requesting client device, a secondary backup client device is also identified and associated with the primary backup client device. The primary and secondary backup client devices' identifiers and network addresses are sent to the requesting client which uses the primary backup client device to process the data. If the primary backup client device can no longer be used as a backup client device, the requesting client may use the secondary backup client device to process the data. In addition, the meeting server 110 is further operative to identify a tertiary backup client device and associate it with the secondary backup client device. This association process may be repeated every time the meeting server 110 detects that a backup client device can no longer be used as a backup client device.

This example is illustrated in FIG. 4 in which client device 130 may request the meeting server 110 to identify one or more relevant backup client devices to process data. By applying selection rules, the meeting server 110 may identify backup client device 131 as the primary backup client device for client device 130. Furthermore, backup client device 132 may be identified as the secondary backup client device and associated with primary backup client device 131. As a result, the data to be processed may be transmitted to the primary backup client device 131 by the meeting server 110 and/or client identifiers and network addresses of primary and secondary backup client devices 131 and 132 are sent to client device 130. Client device 130 is therefore able to transmit the data to primary backup client device 131 for processing.

At some time, the participant using the primary backup client device 131 may decide to leave the online conference session. Since the primary backup client device 131 can no longer be used as a backup client device, the meeting server 110 may transmit the data to be processed for client device 130 to the secondary backup client device 132 and/or client device 130 transmits the data to secondary backup client device 132 for processing. In addition, meeting server 110 identifies a tertiary backup client device 133 as a backup client device for client device 130 and therefore may send the identifier and network address of tertiary backup client device 133 to client device 130.

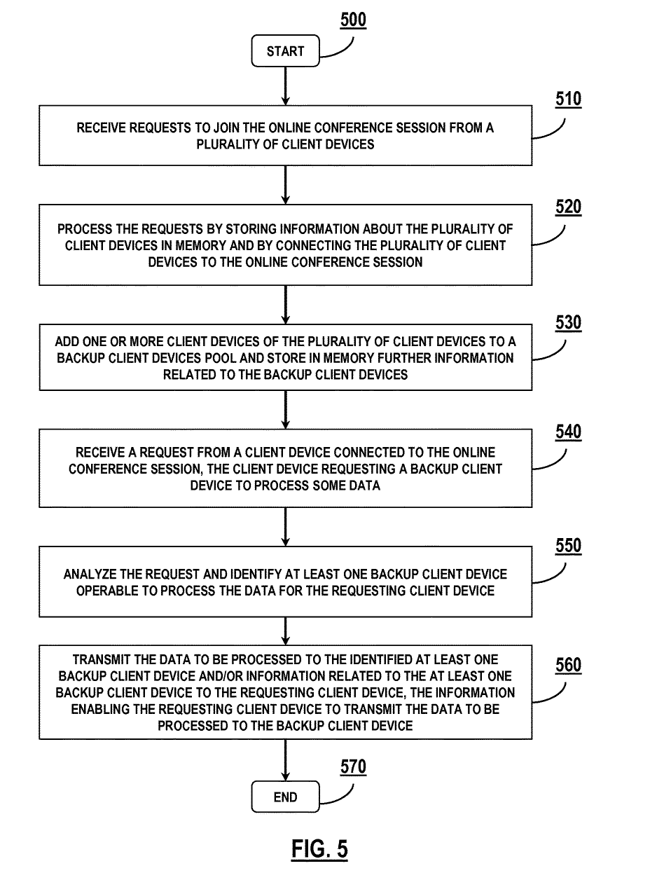

Reference is now made to FIG. 5, which is a flow chart diagram of a method for facilitating an online conference session between a plurality of client devices connected to a meeting server in accordance with an embodiment of the present invention.

The process starts at step 500 and then moves to step 510 in which the network interface of meeting server receives requests to join the online conference session from a plurality of client devices.

At step 520, the requests are processed by a processor of the meeting server and information about the client devices such as, for example, but not limited to, identifiers, network addresses, etc. are stored in a memory of the meeting server. As a result, the plurality of client devices are registered with the meeting server and connected to the online conference session.

In step 530, the processor of the meeting server is further operative to add one or more client devices from the plurality of client devices to a backup client device pool. The available remaining computing resources and/or capacities of the client devices accepting to be part of the pool are stored along with the information provided in step 520. The available remaining computing resources and/or capacities of the client devices may be received from the client devices accepting to be added to pool and/or monitored by the meeting server.

At step 540, the network interface of the meeting server may receive a further request from one client device connected to the online conference session. The request may correspond to a request for the meeting server to identify a backup client device operative to process some data for the requesting client device.

At step 550, the processor of meeting server analyzes the request and identifies at least one backup device, from the backup client devices pool stored in memory, operative to process some of the data for the requesting client device.

At step 560, the meeting server transmits the data to be processed to the identified at least one backup client device and/or transmits information related to the identified at least one backup client device to the requesting client. This information may comprise, for example, but not limited to, the backup client device's identifier, network address, and/or any other information enabling the requesting client to transmit the data to be processed to the at least one backup client device.

The process ends at 570.

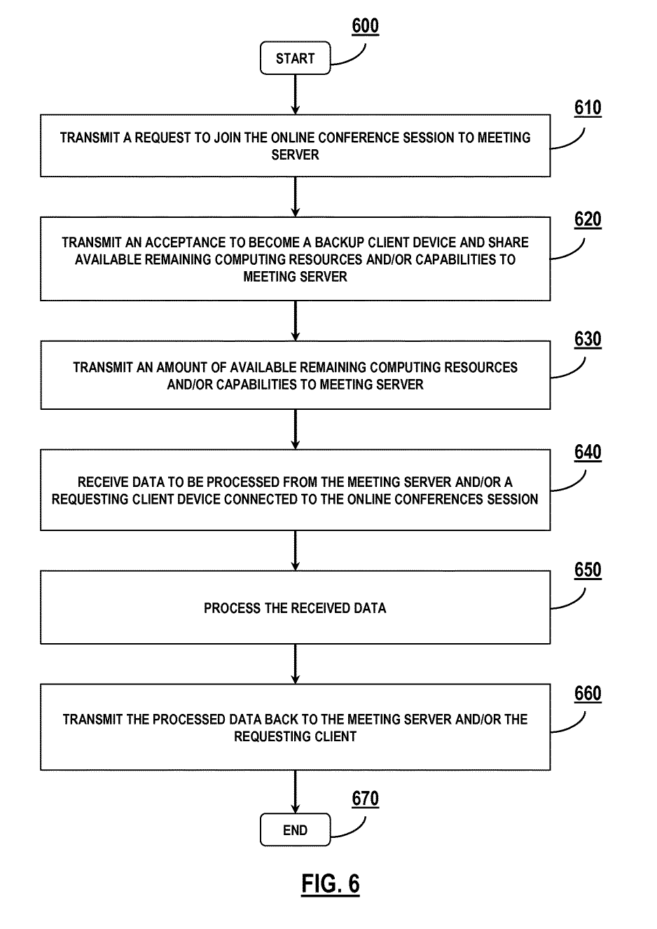

Reference is now made to FIG. 6, which is a flow chart diagram of a method for a backup client device to process data for a requesting client in accordance with an embodiment of the present invention.

The process starts at step 600 and moves to step 610 in which a client device transmits a request to join an online conference session to a meeting server. As a result, the client device is connected to the online conference session once registered with the meeting server.

At step 620, the client device is further operative to transmit to the meeting server an acceptance to become a backup client device and, in turn, to share its available remaining computing resources. This acceptance may be transmitted along with the request to join the online conference session and/or at a later time. As a result, the client device becomes a backup client device that may process data for another client connected to the online conference session.

At step 630, the backup client device further transmits its available remaining computing resources and/or capacities to the meeting server. Alternatively, this transmission may be done at step 610 at the time when the backup client device transmits the acceptance. Also, this step may not be necessary in a situation where the meeting server monitors and retrieves for itself the remaining available computing resources and/or capacities of the different backup client devices.

At step 640, the backup client device receives data to be processed for another client device connected to the online conference session from the meeting server and/or from the requesting client device.

At step 650, the received data are processed by the backup client device.

Then, at step 660, the processed data may be transmitted back to the requesting client and/or to the meeting server.

The process ends at step 670.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method implemented on a meeting server connected to a plurality of client devices, said method comprising:
facilitating an online conference session between a plurality of client devices, said plurality of client devices being connected to said meeting server;
storing information related to one or more backup client devices, said one or more backup client devices corresponding to one or more of said plurality of client devices that accepted to share their computing resources, and said information comprising, for each of said one or more backup client devices a network address and an amount of available computing resources;
receiving, from a client device connected to said meeting server, a request to identify a backup client device operative to process data in place of said client device; and
in response to said request, using said stored information to identify at least one backup client device from said one or more backup client devices, said at least one backup client device having sufficient computing resources available to process said data.

2. The method of claim 1, further comprising transmitting to said requesting client device said network address of said identified at least one backup client device so that said requesting client device can transmit said data to said at least one backup client device for processing.

3. The method of claim 1, further comprising transmitting said data to be processed to said identified at least one backup client device.

4. The method of claim 1, wherein said amount of available computing resources is received from each of said one or more client devices that accepted to share their computing resources and/or capacities.

5. The method of claim 1, wherein said amount of available computing resources is monitored by said meeting server.

6. The method of claim 1, wherein said identifying comprises applying selection rules to identify at least one backup client device, said selection rules being based on one or more of:
an aggregate available computing resources of a backup client device;
an available graphics processing unit capacity of a backup client device;
an available computer processing unit capacity of a backup device;
an available quantity of memory of a backup device;
a type of data supported by a backup client device;
a type of connection supported by a backup client device;
a network bandwidth usable by said backup client device; and
a network geographical proximity of a backup client device.

7. The method of claim 1, wherein said identifying comprises identifying a primary backup client device and a secondary backup client device, said primary and secondary backup client devices having sufficient computing resources available to process said data, said secondary backup client device being used instead of said primary backup client device if said primary backup client device can no longer be used as a backup client device.

8. The method of claim 1, further comprising updating said stored information related to one or more backup client devices by removing stored information related to one backup client device when said backup client device leaves said online conference session.

9. The method of claim 1, further comprising updating said stored information related to one or more backup client devices by removing said stored information related to one backup client device when said backup client device no longer accepts to share its computing resources.

10. The method of claim 1, further comprising updating said stored information related to one or more backup client devices by storing new information related to one backup client device when a new amount of available computing resources is received from said backup client device.

11. A method implemented on a client device connected to a meeting server, said method comprising:
transmitting, to said meeting server, a request to join an online conference session that involves a plurality of client devices;
transmitting, to said meeting server, an acceptance message informing said meeting server that said client device accepts to share its computing resources;
transmitting, to said meeting server, information related to said client device, said information comprising at least a network address and an amount of available computing resources of said client device;
receiving data to process for another client device involved in said online conference session; and
processing said data in place of said other client device.

12. The method of claim 11, wherein said amount of available computing resources of said client device is defined by a user of said client device setting thresholds for one or more of: an available graphics processing unit capacity; an available computer processing unit capacity; and an available quantity of memory.

13. The method of claim 11, wherein said receiving comprises receiving said data to process from said meeting server; and further comprising transmitting said processed data back to said meeting server for subsequent sharing.

14. The method of claim 11, wherein said receiving comprises receiving said data to process from said other client device; and further comprising transmitting said processed data back to said other client for subsequent sharing.

15. A meeting server comprising:
a network interface configured to communicate data from an online conference session between said meeting server and a plurality of client devices;
a memory configured to store information related to one or more backup client devices, said one or more backup client devices corresponding to one or more of said plurality of client devices that accepted to share their computing resources, and said information comprising a network address and an amount of available computing resources for each of said one or more backup client devices;
a processor configured to:
receive, from a client device connected to said meeting server, a request to identify a backup client device operative to process data in place of said client device; and
in response to said request, identify at least one backup client device from said one or more backup client devices using said stored information, said at least one backup client device having sufficient available computing resources to process said data.

16. The meeting server of claim 15, wherein said processor is further configured to transmit to said requesting client device said network address of said at least one backup client device so that said requesting client device can transmit said data to said at least one backup client device for processing.

17. The meeting server of claim 15, wherein said processor is further configured to transmit said data to be processed to said identified at least one backup client device.

18. A client device comprising:
a network interface configured to:
transmit, to a meeting server, a request to join an online conference session that involves a plurality of client devices;
transmit, to said meeting server, an acceptance message informing said meeting server that said client device accepts to share its computing resources;
transmit, to said meeting server, information related to said client device, said information comprising a network address and an amount of available computing resources of said client device;
a processor configured to:
receive data to process for another client device involved in said online conference session; and
process said data in place of said other client device.

19. The client device of claim 18, wherein said processor is configured to receive said data to process from said meeting server; and said processor is further configured to transmit said processed data back to said meeting server for subsequent sharing.

20. The client device of claim 18, wherein said processor is configured to receive said data to process from said other client device; and said processor is further configured to transmit said processed data back to said other client for subsequent sharing.
